(19) United States
(12) Patent Application Publication
(10) Pub. No.: US 2015/0118562 A1
(43) Pub. Date: Apr. 30, 2015

(54) RECHARGEABLE LITHIUM ION BATTERY AND METHOD OF PREPARING THE SAME

(71) Applicant: SAMSUNG SDI CO., LTD., Yongin-si (KR)

(72) Inventors: Masatsugu Nakano, Yokohama-shi (JP); Yuki Takei, Yokohama-shi (JP); Keisuke Nomura, Yokohama-shi (JP)

(21) Appl. No.: 14/523,563

(22) Filed: Oct. 24, 2014

(30) Foreign Application Priority Data
Oct. 25, 2013 (JP) 2013-222457
Aug. 26, 2014 (KR) 10-2014-0111670

(51) Int. Cl. H01M 4/505; C01D 15/02; H01M 4/525; H01M 10/0525

(52) U.S. Cl. CPC H01M 4/505; H01M 10/0525; C01D 15/02; H01M 4/525; H01M 2004/021
USPC 429/221; 429/224; 429/223; 252/182.1

(57) ABSTRACT

A rechargeable lithium ion battery includes a positive electrode including a positive active material; negative electrode; and electrolyte, wherein the rechargeable lithium ion battery is used at a voltage of less than about 4.5 V, and activated by performing a first cycle charging at a voltage of greater than or equal to about 4.55 V, the positive active material is a ternary-component positive active material including a Li₂MnO₃-based solid solution, and an average primary particle diameter of the Li₂MnO₃-based solid solution ranges from about 50 to about 300 nm.

### INCORPORATION BY REFERENCE TO ANY PRIORITY APPLICATIONS

Any and all priority claims identified in the Application Data Sheet, or any correction thereto, are hereby incorporated by reference under 37 CFR 1.57. For example, this application claims priority to and the benefit of Japanese Patent Application No. 2013-222457 filed in the Japanese Patent Office on Oct. 25, 2013, and Korean Patent Application No. 10-2014-0111670 filed in the Korean Intellectual Property Office on Aug. 26, 2014, the disclosures of which are incorporated herein in their entirety.

### BACKGROUND

1. Field

This disclosure relates to a rechargeable lithium ion battery and a method of preparing the same.

2. Description of the Related Technology

Recently, technologies using a Li₂MnO₃-based solid solution as a positive active material to realize high-capacity rechargeable lithium ion battery have been suggested.

The Li₂MnO₃-based solid solution is a solid solution including Li₂MnO₃.

For example, when a rechargeable lithium ion battery including the Li₂MnO₃-based solid solution as a positive active material is charged at a high voltage, high discharge capacity of greater than or equal to about 200 mAh/g may be achieved as shown in JP 2008-270201.

Herein, the rechargeable lithium ion battery using the Li₂MnO₃-based solid solution as a positive active material has a drawback of insufficient cycle-life when repetitively charged and discharged.

In addition, the rechargeable lithium ion battery also has a drawback of shape change of a discharge curved line and deterioration of a discharge voltage when repeatedly charged and discharged at a high voltage.

For example, JP 2008-270201 discloses technologies of improving capacity retention when the rechargeable lithium ion battery using the Li₂MnO₃-based solid solution are charged and discharged at a high voltage by performing its initial charge and discharge and the following charge and discharge under a different condition.

However, the technology of JP 2008-270201 improves capacity retention during repeated charging and discharging at a high voltage but does not suppress either the deterioration of the discharge voltage or the shape change of the discharge curved line.

### SUMMARY

Some embodiments provide a rechargeable lithium ion battery having improved discharge capacity and simultaneously improved cycle characteristics by suppressing voltage drop during charge and discharge.

Some embodiments provide a rechargeable lithium ion battery including a positive electrode; including a positive active material; a negative electrode; and an electrolyte,

wherein the rechargeable lithium ion battery is used at a voltage of less than about 4.5 V, and activated by performing a first cycle charging at a voltage of greater than or equal to about 4.55 V,

the positive active material is a ternary-component positive active material including a Li₂MnO₃-based solid solution, and

an average primary particle diameter of the Li₂MnO₃-based solid solution ranges from about 50 nm to about 300 nm.

The ternary-component positive active material including the Li₂MnO₃-based solid solution may be represented by the following Chemical Formula 1.

xLi₂MnO₃-(1-x)LiMO₂ Chemical Formula 1

In the above Chemical Formula 1, 0.3≦x≦0.5, and M is represented by the following Chemical Formula 2.

MnₐCo_{b}Ni_{c} Chemical Formula 2

In the above Chemical Formula 2, 0.2≦a≦0.5, 0.1≦b≦0.4, and 0.2≦c≦0.5.

A specific surface area of the Li₂MnO₃-based solid solution may range from about 2.5 m²/g to about 10 m²/g.

The ternary-component positive active material including the Li₂MnO₃-based solid solution may be additionally doped with a metal M′ and thus may be represented by the following Chemical Formula 1-1.

xLi₂MnO₃-(1-x)LiMM′O₂ Chemical Formula 1-1

In the above Chemical Formula 1-1,

M′ is selected from Mg, Ti, V, Fe, Al, and a combination thereof,
0.3≦x≦0.5, and
M is represented by the following Chemical Formula 2.

MnₐCo_{b}Ni_{c} Chemical Formula 2

In the above Chemical Formula 2, 0.2≦a≦0.5, 0.1≦b≦0.4, and 0.2≦c≦0.5.

Another embodiment of the present invention provides a method of preparing a rechargeable lithium ion battery that includes agitating dry powders of co-precipitated product of Mn, Co, and Ni and lithium carbonate (Li₂CO₃) at 4 m/s to 5 m/s for about 8 hours to about 12 hours to prepare a mixed powder; and

firing the mixed powder at a temperature of about 700° C. to about 850° C. for about 8 hours to about 12 hours to prepare the ternary-component positive active material including the Li₂MnO₃-based solid solution.

The ternary-component positive active material including the Li₂MnO₃-based solid solution may be represented by the following Chemical Formula 1.

xLi₂MnO₃-(1-x)LiMO₂ Chemical Formula 1

In the above Chemical Formula 1, 0.3≦x≦0.5, and

M is represented by the following Chemical Formula 2:

MnₐCo_{b}Ni_{c} Chemical Formula 2

In the above Chemical Formula 2, 0.2≦a≦0.5, 0.1≦b≦0.4, 0.2≦c≦0.5.

The firing may be performed at a temperature of about 700° C. to about 800° C.

An average primary particle diameter of the Li₂MnO₃-based solid solution may range from about 50 nm to about 300 nm.

A specific surface area of the Li₂MnO₃-based solid solution may range from about 2.5 m²/g to about 10 m²/g.

The ternary-component positive active material including the Li₂MnO₃-based solid solution may be additionally doped with a metal M′ and thus may be represented by the following Chemical Formula 1-1.

xLi₂MnO₃-(1-x)LiMM′O₂ Chemical Formula 1-1

In the above Chemical Formula 1-1,

M′ is selected from Mg, Ti, V, Fe, Al, and a combination thereof,
0.3≦x≦0.5, and
M is represented by the following Chemical Formula 2.

MnₐCo_{b}Ni_{c} Chemical Formula 2

In the above Chemical Formula 2, 0.2≦a≦0.5, 0.1≦b≦0.4, and 0.2≦c≦0.5.

The co-precipitated dry powder may be a hydroxide of each metal element or a carbonate salt of each metal element.

The rechargeable lithium ion battery has improved discharge capacity and simultaneously improved cycle characteristics by suppressing voltage drop during charge and discharge.

### BRIEF DESCRIPTION OF THE DRAWINGS

FIG. 1 is a schematic view showing the structure of a rechargeable lithium ion battery according to one embodiment.

FIG. 2 is a graph showing a correlation between the average primary particle diameter of a Li₂MnO₃-based solid solution and initial discharge capacity.

FIG. 3 is a graph showing a correlation between the average primary particle diameter of the Li₂MnO₃-based solid solution and a voltage drop.

FIG. 4 is a graph showing a correlation between the average primary particle diameter of the Li₂MnO₃-based solid solution and a cycle retention ratio.

FIG. 5 is a graph showing discharge curved lines of Example 3 at the initial discharge and the 300^{th} cycle.

FIG. 6 is a graph showing the cycle-life result of a conventional Li₂MnO₃-based solid solution rechargeable lithium ion battery.

FIG. 7 is a graph showing a discharge curved line of the conventional Li₂MnO₃-based solid solution rechargeable lithium ion battery.

FIG. 8 is a schematic view showing the structural change of the Li₂MnO₃-based solid solution during charge and discharge.

### DETAILED DESCRIPTION

Exemplary embodiments will hereinafter be described in detail. However, these embodiments are only exemplary, and the present disclosure is not limited thereto.

In some embodiments a rechargeable lithium ion battery includes a ternary-component positive active material including a Li₂MnO₃-based solid solution as a positive active material.

However, when a rechargeable lithium ion battery using a positive active material including the Li₂MnO₃-based solid solution (i.e., a Li₂MnO₃-based solid solution rechargeable lithium ion battery) is charged at a high voltage, high-capacity of greater than or equal to about 200 mAh/g may be achieved.

The reason for high capacity is that the Li₂MnO₃-based solid solution undergoes a structural change during the charge and discharge processes.

Specifically, the crystal structure of the Li₂MnO₃-based solid solution may be transferred from a layered crystal structure to a spinel-type crystal structure during charge and from the spinel-type crystal structure to the layered crystal structure during the discharge process.

This structural change may contribute to achieving the high discharge capacity.

On the other hand, the Li₂MnO₃-based solid solution rechargeable lithium ion battery has a problem that it's discharge capacity is deteriorated or that the shape of a discharge curved line is changed as it is repetitively charged and discharged at a high voltage and thus, resulting in an insufficient cycle-life.

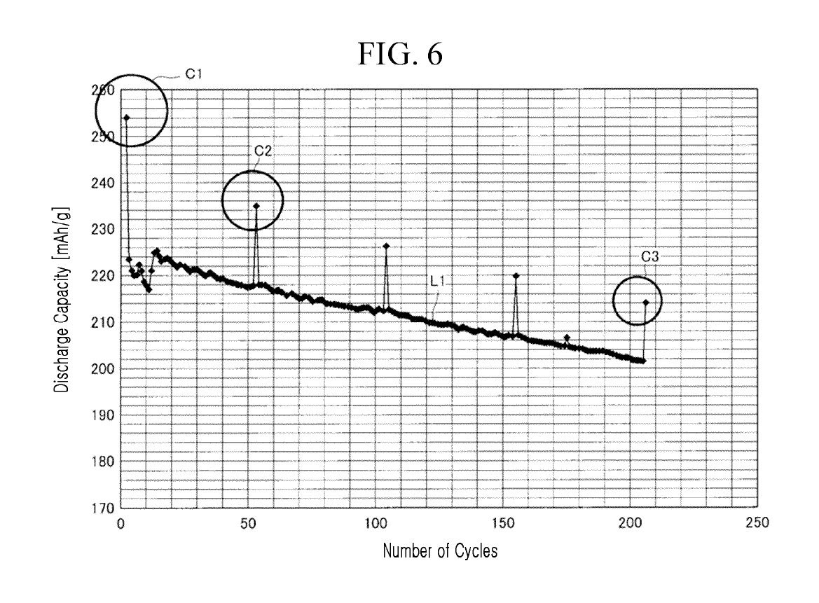

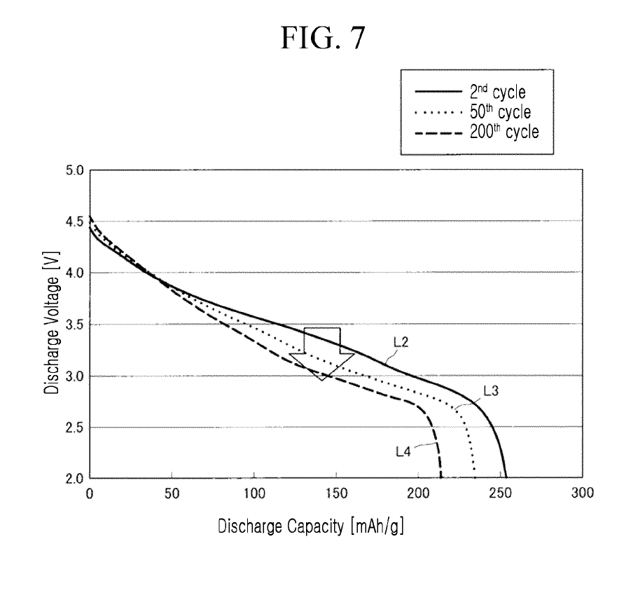

Herein, the discharge curved line and cycle-life problems of the Li₂MnO₃-based solid solution rechargeable lithium ion battery are illustrated referring to FIGS. 6 and 7.

FIG. 6 is a graph showing the cycle-life result of the conventional Li₂MnO₃-based solid solution rechargeable lithium ion battery, and FIG. 7 is a graph showing discharge curved lines of the Li₂MnO₃-based solid solution rechargeable lithium ion battery at the 2^{nd} cycle, the 50^{th} cycle, and the 200^{th} cycle after measuring the discharge capacity in FIG. 6.

FIG. 6 is a graph L1 showing the cycle-life characteristics of Li₂MnO₃-based solid solution rechargeable lithium ion battery.

In FIG. 6, a horizontal axis indicates the number of cycles, and a vertical axis indicates discharge capacity (mAh/g) of a positive active material per unit mass.

In addition, the cycle-life characteristics result shows exact discharge capacity depending on decrease of a charge and discharge rate at every about 50 cycle.

For example, discharge capacities at the 2^{nd} cycle, the 50^{th} cycle, and the 200^{th} cycle (C1, C2, and C3 marked as a circle) indicates their exact discharge capacity values depending on the charge and discharge rate.

Referring to the graph L1, the discharge capacity at the 200^{th} cycle decreases down to about 214 mAh/g from about 254 mAh/g of the discharge capacity at the 2^{nd} cycle, and accordingly, the Li₂MnO₃-based solid solution rechargeable lithium ion battery of FIG. 6 may have insufficient cycle-life characteristic.

In addition, the graphs L2, L3, and L4 in FIG. 7 are discharge curved lines of the Li₂MnO₃-based solid solution rechargeable lithium ion battery measured about discharge capacity at the 2^{nd} cycle, 50^{th} cycle, and 200^{th} cycle in FIG. 6.

In FIG. 7, a horizontal axis indicates discharge capacity (mAh/g), and a vertical axis indicates discharge voltage (V), that is, a voltage of the Li₂MnO₃-based solid solution rechargeable lithium ion battery during discharge.

On the other hand, the discharge capacity of FIG. 7 indicates a value by multiplying a discharge current (mA/g) per unit mass of the positive active material by time (h) taken from a point when the discharge starts to a point when the discharge voltage is measured, and that results in the amount of electricity.

As shown in the graph L2, L3, and L4, the discharge curved lines are changed upon repetition of the charge and discharge cycles.

Specifically, the discharge voltage and discharge capacity decrease, as the charge and discharge cycle is repeated.

Accordingly, the Li₂MnO₃-based solid solution rechargeable lithium ion battery of FIGS. 6 and 7 has a problem that the discharge capacity may not be predicted from the discharge voltage.

For example, the Li₂MnO₃-based solid solution rechargeable lithium ion battery of FIG. 7 has different discharge capacity at each cycle, when the discharge voltage becomes 3.5 V.

Accordingly, since the discharge capacity is different at each cycle at the same discharge voltage, the discharge capacity may not be predicted from the discharge voltage in the Li₂MnO₃-based solid solution rechargeable lithium ion battery.

In addition, since the discharge voltage of the Li₂MnO₃-based solid solution rechargeable lithium ion battery deteriorates over multiple cycles, the deterioration of the discharge voltage may have an influence on a device connected thereto.

Based on the above problem, the Li₂MnO₃-based solid solution rechargeable lithium ion battery may not be easily put into practice.

The above problem was examined and was concluded that the shape change of a discharge curved line and deterioration of a discharge voltage due to repetitive charge and discharge cycles were largely affected by a charge voltage.

Specifically, the shape change of a discharge curved line and the deterioration of a discharge voltage may be suppressed by lowering the charge voltage.

However, when the charge voltage is lowered, high capacity of the Li₂MnO₃-based solid solution rechargeable lithium ion battery may not be achieved, and thus, its discharge capacity may be deteriorated.

In addition, the shape change of a discharge curved line, the charge voltage, and the discharge capacity during repetitive charge and discharge cycles turned out to respectively have a strong correlation with the average primary particle diameter of the Li₂MnO₃-based solid solution.

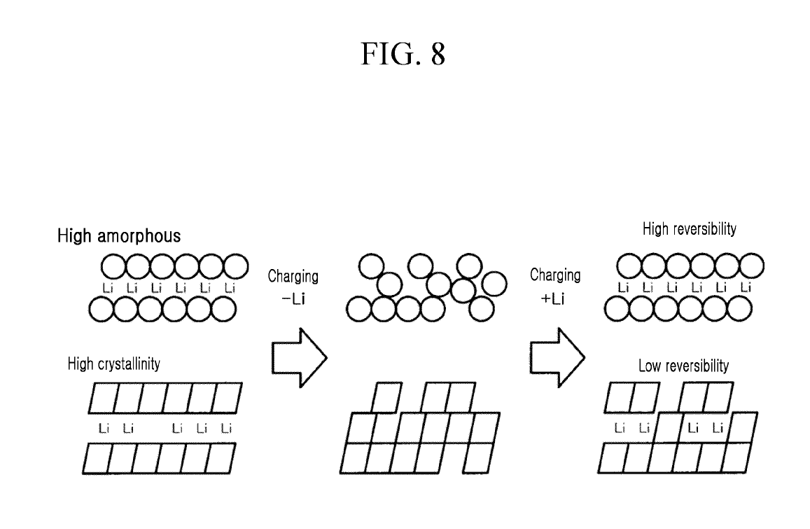

Herein, the correlation between the shape change of a discharge curved line, the charge voltage and the discharge capacity and the average primary particle diameter of the Li₂MnO₃-based solid solution is illustrated by using the crystal structure model of the Li₂MnO₃-based solid solution, referring to FIG. 8.

FIG. 8 is a schematic view showing the structural change of the Li₂MnO₃-based solid solution during charge and discharge.

FIG. 8 shows crystal structure changes of a highly amorphous Li₂MnO₃-based solid solution and a highly crystalline Li₂MnO₃-based solid solution during charge and discharge along with intercalation and deintercalation of Li ions.

Specifically, the crystal structure model of the Li₂MnO₃-based solid solution during discharge is shown at the left and right of FIG. 8, and the crystal structure model of the Li₂MnO₃-based solid solution during charge is shown in the middle of FIG. 8, as shown by the arrow.

On the other hand, an inorganic oxide such as the Li₂MnO₃-based solid solution and the like may have larger particles, as synthesized at higher energy.

Accordingly, since it is synthesized at higher energy as it has a larger particle, the crystal grows easily.

In other words, the highly amorphous Li₂MnO₃-based solid solution is a model having a small average primary particle diameter, and the highly crystalline Li₂MnO₃-based solid solution is a model having a large average primary particle diameter in FIG. 8.

As shown at the left of FIG. 8, the Li₂MnO₃-based solid solution has a layered crystal structure during discharge, and the Li ions are inserted between layers thereof

Herein, when charged, the Li₂MnO₃-based solid solution shows a structural change due to deintercalation of the Li ions and turn into a spinel-type crystal structure as shown in the middle of FIG. 8.

In addition, when discharged, the spinel-type crystal structure of the Li₂MnO₃-based solid solution converts back to a layered crystal structure as the Li ions are intercalated as shown at the right of FIG. 8.

Herein, when the Li₂MnO₃-based solid solution has highly amorphous properties, its crystal structure has low regularity and high flexibility and thus, may be reversibly changed according to intercalation and deintercalation of the Li ions during charging and discharging process.

On the other hand, the highly crystalline Li₂MnO₃-based solid solution has a crystal structure having high regularity and low flexibility and thus, a reversibly low structural change according to intercalation and deintercalation of the Li ions during charging and discharging process.

Accordingly, when the average primary particle diameter of the Li₂MnO₃-based solid solution is highly crystalline, the crystal structure has low flexibility and thus, is partially irreversibly changed during charge and discharge.

Accordingly, when the average primary particle diameter of the Li₂MnO₃-based solid solution is highly crystalline, its layered crystal structure contribution to the charge and discharge process decreases, thus resulting in deterioration of the discharge capacity.

On the other hand, when the Li₂MnO₃-based solid solution has a small average primary particle diameter and highly amorphous properties, its crystal structure is highly flexible and reversibly changed during charge and discharge.

Accordingly, when the Li₂MnO₃-based solid solution has a small average primary particle diameter and highly amorphous properties, its layered crystal structure contribution to charge and discharge process hardly decreases, thus showing no deterioration in the discharge capacity.

In addition, when the highly crystalline Li₂MnO₃-based solid solution is repetitively charged and discharged, its layered crystal structure contribution to charge and discharge process irreversibly slowly decreases during the cycle, generating shape change of the discharge curved line and showing deterioration of a discharge voltage.

On the other hand, even though the Li₂MnO₃-based solid solution having highly amorphous properties is repetitively charged and discharged, its crystal structure is reversibly changed, and subsequently, its layered crystal structure contribution to charge and discharge process is less decreased, causing no shape change of a discharge curved line and no deterioration of a discharge voltage.

On the other hand, when charged at a lower charge voltage, Li ions may be less deintercalated into the Li₂MnO₃-based solid solution.

Accordingly, the charge at a lower charge voltage may suppress irreversible crystal structure of the Li₂MnO₃-based solid solution and the shape change of a discharge curved line but deteriorates the amount of deintercalated Li ions decreases, deteriorating discharge capacity.

However, since the Li₂MnO₃-based solid solution having highly amorphous properties has a crystal structure having high flexibility, the amount of deintercalated Li ions does not decrease despite low deintercalation strength of the Li ions, realizing high discharge capacity.

Accordingly, the present disclosure may suppress the shape change of discharge curved line but improves discharge capacity by charging a positive electrode at a high voltage during the first charge but at a lower charge potential from the 2^{nd} cycle and simultaneously, making the average primary particle diameter of the Li₂MnO₃-based solid solution smaller.

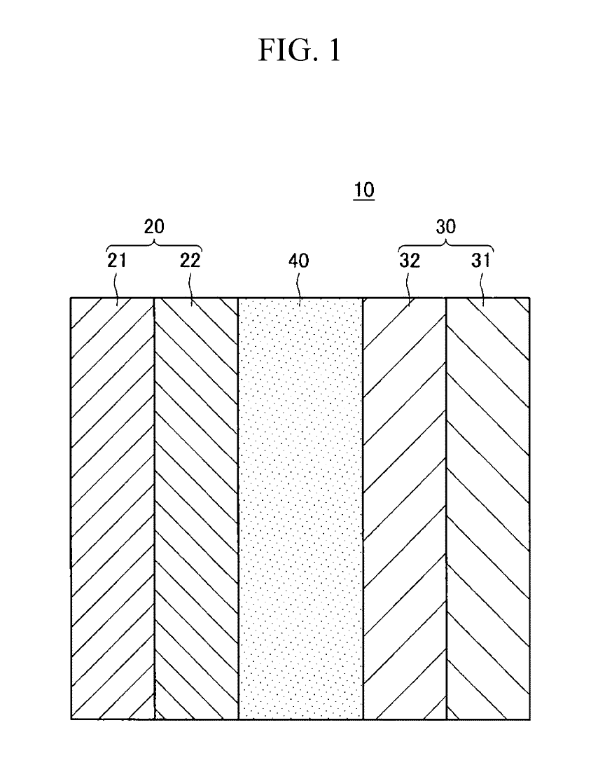

Hereinafter, referring to FIG. 1, a structure of the rechargeable lithium ion battery 10 according to an exemplary embodiment is described.

FIG. 1 is a schematic view showing a structure of a rechargeable lithium ion battery according to one embodiment.

As shown in FIG. 1, a rechargeable lithium ion battery 10 is a Li₂MnO₃-based solid solution rechargeable lithium ion battery, and includes a positive electrode 20, a negative electrode 30, and a separator layer (or separator) 40.

Herein, the rechargeable lithium ion battery 10 may have a charge-reaching voltage (an oxidation reduction potential) of, for example, greater than or equal to about 4.5 V and less than or equal to about 5.0 V (vs. Li/Li⁺).

The rechargeable lithium ion battery 10 has no particular limit in a shape.

For example, the rechargeable lithium ion battery 10 may have a shape such as a cylinder, a prism, a laminate type, a button type and the like.

According to one embodiment, the rechargeable lithium ion battery 10 is charged by setting charge potential of a positive electrode at greater than or equal to about 4.55 V vs. Li during the first charge and at less than about 4.5 V from the 2^{nd} charge. The rechargeable lithium ion battery 10 achieves high discharge capacity and simultaneously, suppresses the shape change of a discharge curved line when charge and discharge cycles are repeated.

Specifically, the first charge is performed at a high charge potential of greater than or equal to about 4.55 V vs. Li to activate the Li₂MnO₃-based solid solution of a positive electrode and to achieve high discharge capacity.

When the first charge is performed at a charge potential of less than about 4.55 V vs. Li, the Li₂MnO₃-based solid solution in the positive electrode is not activated, realizing no high discharge capacity of the rechargeable lithium ion battery 10.

In addition, after activating the Li₂MnO₃-based solid solution of the positive electrode by the first charge, the charges from the 2^{nd} cycle are performed at a relatively low charge potential of less than about 4.5 V vs. Li.

When the rechargeable lithium ion battery 10 according to one embodiment is charged at a high charge potential of greater than or equal to about 4.5 V vs. Li from the 2^{nd} charge, the shape change of a discharge curved line is not suppressed during repetitive charges and discharges, generating a voltage drop.

The positive electrode 20 includes a current collector 21 and a positive active material layer 22.

The current collector 21 may be made of, for example, aluminum (Al).

The positive active material layer 22 includes at least one of a positive active material and a conductive material, and may further include a binder.

The positive active material is a ternary-component positive active material including a Li₂MnO₃-based solid solution.

The Li₂MnO₃-based solid solution is a solid solution including Li₂MnO₃, and may have, for example, a composition represented by the following Chemical Formula 1.

xLi₂MnO₃-(1-x)LiMO₂ Chemical Formula 1

In the above Chemical Formula 1, 0.3≦x≦0.5, M is represented by the following Chemical Formula 2.

MnₐCo_{b}Ni_{c} Chemical Formula 2

In the above Chemical Formula 2, 0.2≦a≦0.5, 0.1≦b≦0.4, and 0.2≦c≦0.5.

When a Li₂MnO₃-based solid solution having the composition is used to manufacture a rechargeable lithium ion battery, the rechargeable lithium ion battery is suppressed from the shape change of a discharge curved line and shows improvement of discharge capacity and cycle characteristics as shown in the following Examples.

An average primary particle diameter of the Li₂MnO₃-based solid solution ranges from about 50 nm to about 300 nm.

As shown in the following Examples, when the average primary particle diameter is within the range, the shape change of a discharge curved line is suppressed, and simultaneously, discharge capacity and cycle characteristics are improved.

Specifically, when the Li₂MnO₃-based solid solution has an average primary particle diameter of less than about 50 nm, a capacity retention is deteriorated during cycles.

On the other hand, when the Li₂MnO₃-based solid solution has an average primary particle diameter of greater than about 300 nm, discharge capacity is deteriorated, and in addition, voltage drop of a discharge curved line becomes larger during repetitive charges and discharges.

Herein, the average primary particle diameter of the Li₂MnO₃-based solid solution may be measured by using SEM (a Scanning Electron Microscope).

Specifically, the average primary particle diameter of the Li₂MnO₃-based solid solution may be obtained by examining the Li₂MnO₃-based solid solution by the SEM and interpreting the SEM image to obtain a particle distribution.

For example, when each primary particle is regarded as a sphere, the average of its diameter may be considered as the average primary particle diameter.

A specific surface area of the Li₂MnO₃-based solid solution may range from about 2.5 m²/g to about 10 m²/g.

As shown in the following Examples, as the specific surface area is within the range, the shape change of a discharge curved line is suppressed, and simultaneously, discharge capacity and cycle characteristics are improved.

In other words, when the Li₂MnO₃-based solid solution has a specific surface area of less than about 2.5 m²/g, shape change of a discharge curved line becomes larger, and discharge capacity is also deteriorated.

On the other hand, when the specific surface area is larger than about 10 m²/g, cycle characteristics are deteriorated.

Herein, the specific surface area may be measured by a well-known method, for example, a nitrogen adsorption method.

On the other hand, the Li₂MnO₃-based solid solution may be additionally doped, since a transition metal other than Ni, Co, and Mn is included therein.

For example, the ternary-component positive active material including the Li₂MnO₃-based solid solution may be doped with M′, and thus may be represented by the following Chemical Formula 1-1.

xLi₂MnO₃-(1-x)LiMM′O₂ Chemical Formula 1-1

In the above Chemical Formula 1-1,

M′ is selected from Mg, Ti, V, Fe, Al, and a combination thereof,
0.3≦x≦0.5, and
M is represented by the following Chemical Formula 2.

MnₐCo_{b}Ni_{c} Chemical Formula 2

In the above Chemical Formula 2, 0.2≦a≦0.5, 0.1≦b≦0.4, 0.2≦c≦0.5.

The content of the Li₂MnO₃-based solid solution is not particularly limited, and may be any content that may be applied in a positive active material layer of a rechargeable lithium ion battery.

The conductive material may be, for example carbon black such as ketjen black, acetylene black, and the like, natural graphite, artificial graphite, and the like.

However, the conductive material may be any one in order to improve conductivity of a positive electrode without limitation.

The content of the conductive material is not particularly limited, and may be any content that may be applied in a positive active material layer of a rechargeable lithium ion battery.

The binder may be, for example polyvinylidene fluoride, an ethylene-propylene-diene terpolymer, a styrene-butadiene rubber, an acrylonitrile-butadiene rubber, fluororubber, polyvinyl acetate, polymethyl methacrylate, polyethylene, nitrocellulose, and the like.

But the binder may not be particularly limited if it binds the positive active material and the conductive material on the current collector 21.

The content of the binder is not particularly limited, and may be any content that may be applied in a positive active material layer of a rechargeable lithium ion battery.

The positive active material layer 22 is formed by, for example, dispersing a positive active material, a conductive material and a binder into an appropriate organic solvent (for example, N-methyl-2-pyrrolidone) to prepare slurry, coating the slurry on a current collector, and then, drying and compressing it.

The negative electrode 30 includes a current collector 31, and a negative active material layer 32.

The current collector 31 may be made of, for example, copper (Cu), nickel (Ni), and the like.

Herein, the negative active material layer 32 may be any one that is used in a negative active material layer of a rechargeable lithium ion battery.

For example, the negative active material layer 32 includes a negative active material, and may further include a binder.

The negative active material may be, for example, a graphite active material (artificial graphite, natural graphite, a mixture of artificial graphite and natural graphite, natural graphite coated with artificial graphite, and the like), a mixture of a particulate of silicon (Si) or tin (Sn) or oxides thereof and a graphite active material, a silicon or tin particulate, an alloy including silicon or tin as a basic material, and titanium oxide (TiOₓ) compound such as Li₄Ti₅O₁₂ and the like.

The silicon oxide may be represented by SiOₓ (0≦x≦2).

The negative active material may be, for example metal lithium and the like besides the above materials.

The binder may be the same as the binder of the positive active material layer 22.

A weight ratio of the negative active material and the binder is not particularly limited, and may be any one that may be adopted in a conventional rechargeable lithium ion battery.

The separator layer 40 includes a separator and an electrolyte.

The separator is not particularly limited, and may be any separator usable in a rechargeable lithium ion battery.

The separator may be preferable a porous film or a non-woven fabric having excellent high rate discharge performance that may be used singularly or with other materials.

The separator may be coated with an inorganic material such as Al₂O₃, SiO₂ and the like.

The materials constituting the separator may be, for example, a polyolefin-based resin such as polyethylene, polypropylene, and the like, a polyester-based resin such as polyethylene terephthalate, polybutylene terephthalate, and the like, a polyvinylidene difluoride, vinylidene fluoride-hexafluoro propylene copolymer, a vinylidene fluoride-perfluoro vinylether copolymer, a vinylidene fluoride-tetrafluoroethylene copolymer, a vinylidene fluoride-trifluoro ethylene copolymer, a vinylidene fluoride-fluoro ethylene copolymer, a vinylidene fluoride-hexafluoro acetone copolymer, a vinylidene fluoride-ethylene copolymer, a vinylidene fluoride-propylene copolymer, a vinylidene fluoride-trifluoro propylene copolymer, a vinylidene fluoride-tetrafluoroethylene-hexafluoro propylene copolymer, a vinylidene fluoride-ethylene-tetrafluoroethylene copolymer, and the like.

The porosity of the separator not particularly limited, and may be any porosity which a separator of a conventional rechargeable lithium ion battery has.

The electrolyte solution may be a non-aqueous electrolyte that is usable in a conventional rechargeable lithium battery and is not particularly limited.

The electrolyte solution has a composition in which an electrolytic salt is included in a non-aqueous solvent.

The non-aqueous solvent may be, for example, cyclic carbonate esters such as propylene carbonate, ethylene carbonate, butylene carbonate, chloroethylene carbonate, vinylene carbonate, and the like; cyclic esters such as γ-butyrolactone, γ-valero lactone and the like; linear carbonates such as dimethyl carbonate, diethylcarbonate, ethylmethyl carbonate, and the like; linear esters such as methyl formate, methyl acetate, methyl butyrate, and the like; ethers such as tetrahydrofuran or a derivative thereof; ethers such as 1,3-dioxane, 1,4-dioxane, 1,2-dimethoxy ethane, 1,4-dibutoxyethane, methyl diglyme and the like; nitriles such as acetonitrile, benzonitrile, and the like; dioxolane or a derivative thereof; ethylene sulfide, sulfolane, sultone or a derivative thereof which may be used singularly or as a mixture of two or more, without limitation.

The electrolytic salt may be, for example, an inorganic ion salt including lithium (Li), sodium (Na) or potassium (K) such as LiClO₄, LiBF₄, LiAsF₆, LiPF₆, LiSCN, LiBr, LiI, Li₂SO₄, Li₂B₁₀Cl₁₀, NaClO₄, NaI, NaSCN, NaBr, KClO₄, KSCN, and the like, LiCF₃SO₃, LiN(CF₃SO₂)₂, LiN(C₂F₅SO₂)₂, LiN(CF₃SO₂) (C₄F₉SO₂), LiC(CF₃SO₂)₃, LiC(C₂F₅SO₂)₃, (CH₃)₄NBF₄, (CH₃)₄NBr, (C₂H₅)₄NClO₄, (C₂H₅)₄NI, (C₃H₇)₄NBr, (n-C₄H₉)₄NClO₄, (n-C₄H₉)₄NI, an organic ion salt such as (C₂H₅)₄N-maleate, (C₂H₅)₄N-benzoate, (C₂H₅)₄N-phthalate, lithium stearyl sulfate, lithium octyl sulfate, lithium dodecylbenzene sulphonate, and the like.

These ionic compounds may be used singularly or as mixtures of two or more.

The concentration of the electrolytic salt may be the same as a non-aqueous electrolyte in a conventional rechargeable lithium battery, and is not particularly limited.

In the present invention, an electrolyte solution including an appropriate lithium compound (electrolytic salt) at a concentration of about 0.5 mol/L to about 2.0 mol/L may be used.

Hereinafter, a specific embodiment of the present invention, a method of preparing the Li₂MnO₃-based solid solution is described.

The method of preparing the Li₂MnO₃-based solid solution is not particularly limited, but for example, may be prepared by a co-precipitation method using a hydroxide (hereinafter, referred to as a hydroxide method) or by a co-precipitation method using a carbonate salt (hereinafter, referred to as a carbonate salt method).

The hydroxide method includes co-precipitating hydroxides as a precursor of the Li₂MnO₃-based solid solution, and mixing the resultant with Li₂CO₃ followed by firing to prepare the Li₂MnO₃-based solid solution.

The carbonate salt method includes co-precipitating hydroxides as a precursor of the Li₂MnO₃-based solid solution, and mixing the resultant with Li₂CO₃ followed by firing to prepare the Li₂MnO₃-based solid solution.

On the other hand, the carbonate salt method may provide a Li₂MnO₃-based solid solution having a smaller particle diameter than the hydroxide method.

Herein, the Li₂MnO₃-based solid solution according to one embodiment may have a smaller average primary particle diameter so that it may have amorphous properties having highly flexible crystal structure and thus improve discharge capacity.

Accordingly, the carbonate salt method to provide a Li₂MnO₃-based solid solution having a smaller particle diameter may be more desirable for preparing the Li₂MnO₃-based solid solution according to one embodiment.

However, the present disclosure is illustrated in more detail with reference to examples.

Furthermore, what is not described in this disclosure may be sufficiently understood by those who have knowledge in this field and will not be illustrated here.

### Example A

### Method of Preparing Li₂MnO₃-Based Solid Solution Using Hydroxide Method

Hereinafter, a method of preparing a Li₂MnO₃-based solid solution by using a hydroxide method is illustrated by the following procedure.

First of all, nickel (Ni) sulfate hexahydrate, manganese (Mn) sulfate heptahydrate and cobalt (Co) sulfate pentahydrate are dissolved in ion exchange water, preparing a mixed aqueous solution.

Herein, the total weight of the nickel sulfate hexahydrate, manganese sulfate heptahydrate and cobalt sulfate pentahydrate is for example about 20 wt % based on the entire weight of the mixed aqueous solution.

In addition, the nickel sulfate hexahydrate, the manganese sulfate heptahydrate and the cobalt sulfate pentahydrate are mixed to have a desired mole ratio among Ni, Co and Mn.

On the other hand, the mole ratio of each element is determined depending on the composition of the Li₂MnO₃-based solid solution.

For example, 0.4Li₂MnO₃-0.6Li(Mn_{0.33}Co_{0.33}Ni_{0.33})O₂ is manufactured in a mole ratio of Ni:Co:Mn=20:20:60.

In addition, a predetermined amount (for example, 500 ml) of the ion exchange water is added to the resultant reaction layer, and this ion exchange water is maintained at 50° C.

Hereinafter, the aqueous solution in the reaction layer is called to be a reaction layer aqueous solution.

Then, 40 wt % of a NaOH aqueous solution (including 40 wt % of NaOH based on the total weight of the aqueous solution) is added to the ion exchange water in a dropwise fashion to adjust pH of the reaction layer aqueous solution into 11.5.

The ion exchange water is bubbled by inert gas such as nitrogen and the like to remove the dissolved oxygen.

Herein, the reaction layer aqueous solution is agitated, and the above mixed aqueous solution is added thereto in a dropwise fashion while the reaction layer aqueous solution is maintained at 50° C.

The rate of addition is not particularly limited, but a uniform precursor (co-precipitated hydroxide) may not be obtained if the speed is excessively fast.

Accordingly, the rate of addition may be, for example, about 3 ml/min.

In addition, 40 wt % of a NaOH aqueous solution and 10 wt % of a NH₃ aqueous solution (including 10 wt % of NH₃ based on the total weight of the aqueous solution) other than the mixed aqueous solution is added to the reaction layer aqueous solution in a dropwise fashion.

During this dripping, the reaction layer aqueous solution is maintained at pH of 11.5 and a temperature of 50° C.

In this way, a hydroxide of each metal element is co-precipitated.

Subsequently, the co-precipitated hydroxide is taken from the reaction layer aqueous solution by performing a solid-liquid separation (for example, an absorption filter) and then, cleaned with ion exchange water.

In addition, the co-precipitated hydroxide is vacuum-dried.

The vacuum drying is performed, for example, at 100° C. for about 10 hours.

Then, the dried co-precipitated hydroxide is ground with a mortar and pestle for several minutes, obtaining a dry powder.

The dry powder is mixed with lithium carbonate (Li₂CO₃), obtaining a mixed powder.

Herein, a mole ratio of Li and M (═Ni+Mn+Co) is determined depending on the composition of the solid solution.

For example, 0.4Li₂MnO₃-0.6Li (Mn_{0.33}Co_{0.33}Ni_{0.33})O₂ is manufactured by adjusting the mole ratio of Li:M=1.4:1.

In addition, the mixed powder is fired.

In this way, the Li₂MnO₃-based solid solution is prepared.

Herein, the Li₂MnO₃-based solid solution has an average primary particle diameter and a specific surface area within each predetermined range in one embodiment, but the average primary particle diameter tends to be smaller (a specific surface area tends to be larger), specifically as the agitation is performed at a higher speed and for a shorter time.

As the firing is performed for a shorter time at a lower temperature, the average primary particle diameter tends to be smaller (the specific surface area tends to be larger).

For example, the average primary particle diameter may be in a range of about 50 nm to about 300 nm, and the specific surface area may be in a range of greater than or equal to about 2.5 m²/g and less than or equal to about 10 m²/g by adjusting the firing temperature in a range of about 700° C. to about 850° C. after setting the agitation speed in a range of about 4 m/s to about 5 m/s, the agitation time for about 10 hours, and the firing time for about 10 hours.

### Example B

### Method of Preparing Li₂MnO₃-Based Solid Solution Using Carbonate Salt Method

A method of preparing a Li₂MnO₃-based solid solution in a carbonate salt method is illustrated by the following procedure.

First of all, nickel sulfate hexahydrate, manganese sulfate heptahydrate and cobalt sulfate pentahydrate are dissolved in ion exchange water, preparing a mixed aqueous solution.

The method of preparing the mixed aqueous solution is the same as a hydroxide method as described earlier in Example A.

In addition, a predetermined amount of (for example, 500 ml) ion exchange water is added to the reaction layer, and the ion exchange water is maintained at 50° C.

The aqueous solution in the reaction layer is called to be a reaction layer aqueous solution like in the hydroxide method.

Next, the ion exchange water is bubbled by inert gas such as nitrogen and the like to remove the dissolved oxygen.

Herein, the reaction layer aqueous solution is agitated, and the mixed aqueous solution is added thereto in a dropwise fashion, while the reaction layer aqueous solution is maintained at 50° C.

The rate of addition has no particular limit on its speed, but a uniform precursor (co-precipitated carbonate salt) may not be obtained if the speed is too fast.

Accordingly, the rate may be, for example, about 3 ml/min.

In addition, a Na₂CO₃ saturated aqueous solution excessively with Ni, Mn, and Co which are also included in the mixed aqueous solution other than the mixed aqueous solution is added to the reaction layer aqueous solution in a dropwise fashion.

On the other hand, the reaction layer aqueous solution is maintained at pH of 8.5 and a temperature of 50° C. during the addition.

In this way, a carbonate salt of each metal element is co-precipitated.

Subsequently, the co-precipitated carbonate salt is taken from the reaction layer aqueous solution by performing a solid-liquid separation (for example, an absorption filter) and then, cleaned with ion exchange water and vacuum-dried.

In addition, the dried co-precipitated carbonate salt is ground and mixed with lithium carbonate (Li₂CO₃), forming mixed powder.

The cleaning, drying and grinding of the co-precipitated carbonate salt and the mixing of the co-precipitated carbonate salt with the lithium carbonate (Li₂CO₃) are the same as those of the hydroxide method in Example A.

In this way, the instant Li₂MnO₃-based solid solution is manufactured.

Herein, the Li₂MnO₃-based solid solution according to one embodiment has an average primary particle diameter and a specific surface area within each predetermined range, but the average primary particle diameter and the specific surface area may be adjusted by controlling the above agitation speed, agitation time, firing time, firing temperature and so on, like the co-precipitation method using a hydroxide.

For example, the average primary particle diameter may be in a range of about 50 nm to about 300 nm, and the specific surface area may be in a range of greater than or equal to about 2.5 m²/g to less than or equal to about 10 m²/g by setting the agitation speed in a range of about 4 m/s to about 5 m/s, the agitation time to be about 10 hours, the firing time to be about 10 hours, and the firing temperature in a range of about 700° C. to about 800° C.

### Example C

### Manufacture of Rechargeable Lithium Battery Cell

According to one embodiment, a rechargeable lithium ion battery cell may be manufactured in the same method as a conventional Li₂MnO₃-based solid solution rechargeable lithium ion battery cell except for using a Li₂MnO₃-based solid solution according to the above method.

A schematic method of manufacturing the rechargeable lithium ion battery cell according to one embodiment is described as follows.

A positive electrode is manufactured as follows.

First of all, a positive active material, a conductive material and a binder are mixed in a desired ratio and then, dispersed into an organic solvent (for example, N-methyl-2-pyrrolidone), forming slurry.

Then, the slurry is formed (for example, coated) on a current collector and dried, forming a positive active material layer.

On the other hand, the coating is not particularly limited but may be performed by using, for example, a knife coater, a gravure coater, and the like.

The following coating processes are performed in the same method.

In addition, the positive active material layer is compressed to have a desired thickness by using a compressor.

In this way, the positive electrode is manufactured.

Herein, the positive active material layer has no particular limit in a thickness but may have any thickness that a positive active material layer for a rechargeable lithium ion battery cell has.

A negative electrode is manufactured according to the same method as the positive electrode.

First of all, a negative active material and a binder are mixed in a desired ratio and then, dispersed into an organic solvent (for example, N-methyl-2-pyrrolidone), forming slurry.

The slurry was formed (for example, coated) on a current collector and then, dried, forming a negative active material layer.

In addition, the negative active material layer is compressed to have a desired thickness by using a compressor.

In this way, the negative electrode is manufactured.

Herein, the negative active material layer has no particular limit in a thickness but may have any thickness that a negative active material layer for a rechargeable lithium ion battery has.

In addition, when lithium is used to form the negative active material layer, a lithium metal foil may be overlapped on a current collector.

Subsequently, a separator is interposed between the positive and negative electrodes, manufacturing an electrode structure.

Next, the electrode structure is processed to have a desired shape (for example, a cylinder, a prism, a laminate-type, a button shape, and the like) and inserted in a container having the same shape.

In addition, an electrolyte having a desired composition is inserted into the container to impregnate each pore in the separator with the electrolyte solution.

In this way, the rechargeable lithium ion battery cell is manufactured.

Hereinafter, Examples according to one embodiment is illustrated.

### Preparation of Li₂MnO₃-Based Solid Solutions According to Examples 1 to 4 and Comparative Examples 1 to 5

First of all, each Li₂MnO₃-based solid solution according to Examples 1 to 4 and Comparative Examples 1 to 5 was manufactured by using a carbonate salt method.

Specifically, nickel sulfate hexahydrate, manganese sulfate heptahydrate and cobalt sulfate pentahydrate were dissolved in ion exchange water, preparing a mixed aqueous solution.

Herein, the total mass of the nickel sulfate hexahydrate, manganese sulfate heptahydrate and cobalt sulfate pentahydrate was 20 wt % based on the entire weight of the mixed aqueous solution.

In addition, the nickel sulfate hexahydrate, manganese sulfate heptahydrate and cobalt sulfate pentahydrate were mixed in a mole ratio of Ni:Co:Mn of 20:20:60.

Furthermore, 500 ml of the ion exchange water was added to the reaction layer, and the ion exchange water was maintained at 50° C.

Then, the ion exchange water was bubbled by nitrogen gas to remove the dissolved oxygen.

Subsequently, the reaction layer aqueous solution was agitated, and the above mixed aqueous solution was added thereto in a dropwise fashion at a rate of 3 ml/min while the reaction layer aqueous solution was maintained at 50° C.

In addition, a Na₂CO₃ saturated aqueous solution oversaturated with the Ni, Mn, and Co of the mixed aqueous solution other than the mixed aqueous solution was added to the reaction layer aqueous solution in a dropwise fashion, and the reaction layer aqueous solution was maintained at pH of 8.5.

Herein, the mixture was agitated at a speed of 4 m/s to 5 m/s for 10 hours.

Accordingly, a carbonate salt of each metal element was co-precipitated.

Subsequently, the co-precipitated carbonate salt was taken from the reaction layer aqueous solution through an absorption filter and cleaned with ion exchange water.

Then, the co-precipitated carbonate salt was vacuum-dried.

The vacuum-drying was performed at 100° C. for 10 hours.

Then, the co-precipitated carbonate salt after the drying was ground with a mortar and a pestle for several minutes, obtaining a dry powder.

The dry powder was mixed with lithium carbonate (Li₂CO₃), obtaining a mixed powder.

Herein, the Li and the M (═Ni+Mn+Co) had a mole ratio of 1.4:1.

In addition, the mixed powder was divided into three groups and respectively fired at different temperatures in a range of about 700° C. to about 800° C.

Herein, the firing was performed for 10 hours in all the experimental data.

The firing at different temperatures provided the Li₂MnO₃-based solid solutions having different average primary particle diameters according to Examples 1 to 4 and Comparative Examples 1 to 5.

On the other hand, the average primary particle diameter of each Li₂MnO₃-based solid solution was obtained by analyzing an SEM image, and its specific surface area was measured in a nitrogen adsorption method.

On the other hand, the firing temperature, the average primary particle diameter and the specific surface area of the Li₂MnO₃-based solid solutions according to Examples 1 to 4 and Comparative Examples 1 to 5 were provided with their charge and discharge evaluation result in the following Table 2.

### Li₂MnO₃-Based Solid Solutions According to Examples 5 to 8 and Comparative Examples 6 and 7

The Li₂MnO₃-based solid solutions according to Examples 5 to 8 and Comparative Examples 6 and 7 were manufactured by using a hydroxide method.

Specifically, nickel sulfate hexahydrate, manganese sulfate heptahydrate and cobalt sulfate 5 hydrate were dissolved in ion exchange water, preparing a mixed aqueous solution.

Herein, the total mass of the nickel sulfate hexahydrate, the manganese sulfate heptahydrate and cobalt sulfate pentahydrate was 20 wt % based on the total weight of the mixed aqueous solution.

In addition, the nickel sulfate hexahydrate, manganese sulfate heptahydrate and cobalt sulfate pentahydrate were mixed in a mole ratio of Ni:Co:Mn=20:20:60.

Furthermore, 500 ml of the ion exchange water was added to the reaction layer, and this ion exchange water was maintained at 50° C.

Next, 40% by mass of NaOH aqueous solution was added to the ion exchange water in a dropwise fashion to adjust the reaction layer aqueous solution to have pH of 11.5.

Then, the ion exchange water was bubbled by nitrogen gas to remove the dissolved oxygen.

Then, the reaction layer aqueous solution was agitated, and the above mixed aqueous solution was added thereto in a dropwise fashion at a speed of 3 ml/min while the reaction layer aqueous solution was maintained at 50° C.

In addition, 40% by mass of a NaOH aqueous solution and 10 wt % of a NH₃ aqueous solution other than the mixed aqueous solution were added thereto in a dropwise fashion to maintain pH of the reaction layer aqueous solution at 11.5.

Herein, the mixture was agitated at a speed of 4 m/s to 5 m/s for 10 hours.

Accordingly, a hydroxide of each metal element was co-precipitated.

Subsequently, the co-precipitated hydroxide was taken out of the reaction layer aqueous solution through an absorption filter and then, cleaned with ion exchange water.

Then, the co-precipitated hydroxide was vacuum-dried.

The vacuum-drying was performed at 100° C. for 10 hours.

Next, the co-precipitated hydroxide was ground with a mortar and a pestle for several minutes, obtaining a dry powder.

The dry powder was mixed with lithium carbonate (Li₂CO₃), producing mixed powder.

Herein, the Li and the M (═Ni+Mn+Co) had a mole ratio of 1.4:1.

In addition, this mixed powder was divided into three groups and fired at different temperatures in a range of 700° C. to 800° C.

Herein, the firing was performed for 10 hours about all the samples.

The firing at different temperatures provided Li₂MnO₃-based solid solutions having different average primary particle diameters according to Examples 5 to 8 and Comparative Examples 6 and 7.

On the other hand, the average primary particle diameter of each Li₂MnO₃-based solid solution was obtained by analyzing its SEM image, and its specific surface area was measured in a nitrogen adsorption method.

In addition, the firing temperature, the average primary particle diameter, and the specific surface area of the Li₂MnO₃-based solid solutions according to Examples 5 to 8 and Comparative Examples 6 and 7 were provided along with the charge and discharge evaluation results in the following Table 2.

### Manufacture of Rechargeable Lithium Ion Battery Cell

A rechargeable lithium ion battery cell was manufactured as follows.

First of all, each Li₂MnO₃-based solid solution manufactured according to the above method, acetylene black, and polyvinylidene fluoride were mixed in a weight ratio of 80:13:7.

This mixture was dispersed into N-methyl-2-pyrrolidone, forming slurry.

Subsequently, the slurry was coated on an aluminum foil as a current collector and dried to form a positive active material layer, which was used to manufacture a positive electrode.

The positive active material layer was 50 μm thick.

In addition, a negative electrode was manufactured by using graphite.

Subsequently, as for a separator, a porous polyethylene film (a thickness of 12 μm) was used, and the separator was interposed between the positive and negative electrodes, manufacturing an electrode structure.

The electrode structure was processed to have a size of a 2032 coin cell and housed in a 2032 coin cell container.

On the other hand, an electrolyte solution was manufactured by mixing ethylene carbonate and dimethyl carbonate in a volume ratio of 3:7 to obtain a non-aqueous solvent and dissolving lithium hexafluoro phosphate (LiPF₆) in a concentration of 1.3 mol/L in the non-aqueous solvent.

The electrolyte solution was injected into the coin cell and thus, the separator was impregnated therewith.

In this way, the rechargeable lithium ion battery cell was manufactured.

### Evaluation Examples

### Performance Comparison of Electrolyte Solutions

### Evaluation Example 1

### Cycle-Life Characteristics of Rechargeable Lithium Battery Cell

The rechargeable lithium ion battery cells were cycle-tested at a charge and discharge rate and a cut-off voltage provided in the following Table 1.

TABLE 1

| | Charge rate | Discharge rate | |
|---|---|---|---|
| Cycle | (CC-CV) | (CC) | Cut-off voltage [V] |
| 1 | 0.1 C | 0.1 C | 4.55-2.0 |
| 2 | 0.2 C | 0.2 C | 4.55, 4.45, 4.35-2.5 |
| 3-299 | 1 C | 1 C | 4.55, 4.45, 4.35-2.5 |
| 300 | 0.2 C | 0.2 C | 4.55, 4.45, 4.35-2.5 |

In Table 1, the CC-CV indicates a constant current/constant voltage charge, and the CC indicates a constant current discharge.

The cut-off voltage indicates a voltage where a charge ends and a voltage where a discharge ends.

For example, at the first cycle, the rechargeable lithium ion battery cell was charged until its voltage became 4.55 V and discharged until its voltage became 2.0 V.

As shown in Table 1, the charge and discharge at the first cycle was performed at a high charge voltage of 4.55 V to activate the Li₂MnO₃-based solid solution.

At the 2^{nd} and 300^{th} cycles, the rechargeable lithium ion battery cell was charged and discharged at a low rate, and its discharge voltage and discharge capacity were precisely measured.

At the 3^{rd} to the 299^{th} cycles, the charge and discharge were repeated at a high rate.

### Evaluation Example 2

### Discharge Capacity and Voltage Drop Capability of Rechargeable Lithium Battery Cell

A charge voltage at the 3^{rd} to the 299^{th} cycles was changed, for example, respectively 4.55 V, 4.45 V, and 4.35 V in Examples 1 to 8 and Comparative Examples 1 to 7 as shown in Table 2.

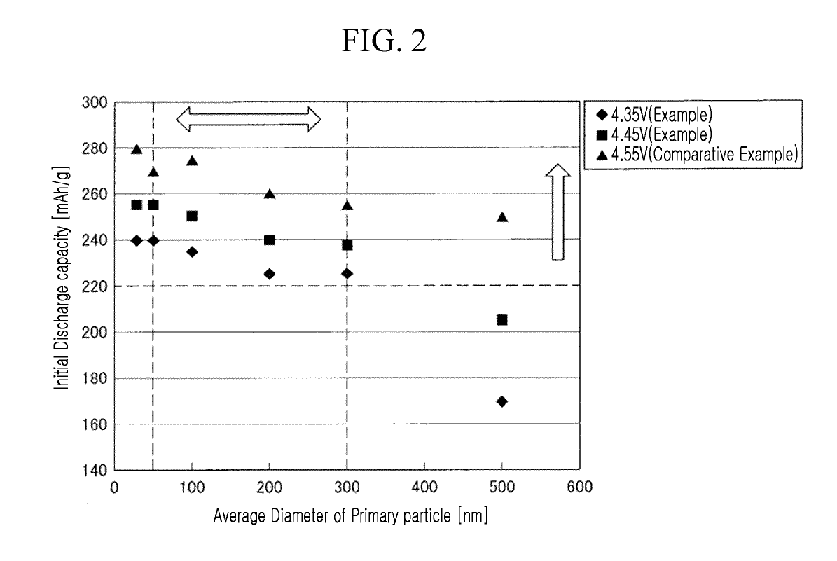

This charge and discharge evaluation results are provided in Table 2 and FIGS. 2 to 4.

On the other hand, the charge voltage in Table 2 was a charge voltage when the negative electrode was graphite (i.e., relative to a graphite charge voltage), but the charge voltage vs. graphite is equal to a charge potential vs. Li of the positive electrode since the graphite had a potential of almost 0 V at the end of the charge.

Accordingly, the charge voltage vs. graphite in Table 2 is regarded to be equal to a charge potential vs. Li of the positive electrode.

TABLE 2

| | | | Average | | Charge | Initial | | |
|---|---|---|---|---|---|---|---|---|
| | | | primary | | voltage | discharge | | Cycle |
| | | Firing | particle | | during | capacity | Voltage | retention |
| | Synthesis | temperature | diameter | BET | cycle (V) | (2 cycle) | drop | ratio |
| | method | (° C.) | (nm) | (m²/g) | (vs. Gr) | (mAh/g) | (V) | (%) |
| Comparative | carbonate | 700 | 30 | 11.0 | 4.35 | 240 | 0.01 | 70 |
| Example 1 | salt method | | | | | | | |
| Comparative | carbonate | | | | 4.45 | 255 | 0.03 | 66 |
| Example 2 | salt method | | | | | | | |
| Comparative | carbonate | | | | 4.55 | 280 | 0.06 | 62 |
| Example 3 | salt method | | | | | | | |
| Example 1 | carbonate | 750 | 50 | 8.3 | 4.35 | 240 | 0.01 | 86 |
| | salt method | | | | | | | |
| Example 2 | carbonate | | | | 4.45 | 255 | 0.03 | 82 |
| | salt method | | | | | | | |
| Comparative | carbonate | | | | 4.55 | 270 | 0.06 | 72 |
| Example 4 | salt method | | | | | | | |
| Example 3 | carbonate | 800 | 100 | 6.2 | 4.35 | 235 | 0.02 | 88 |
| | salt method | | | | | | | |
| Example 4 | carbonate | | | | 4.45 | 250 | 0.04 | 84 |
| | salt method | | | | | | | |
| Comparative | carbonate | | | | 4.55 | 275 | 0.1 | 75 |
| Example 5 | salt method | | | | | | | |
| Example 5 | hydroxide | 750 | 200 | 4.5 | 4.35 | 225 | 0.02 | 88 |
| | method | | | | | | | |
| Example 6 | hydroxide | | | | 4.45 | 240 | 0.05 | 84 |
| | method | | | | | | | |
| Comparative | hydroxide | | | | 4.55 | 260 | 0.12 | 75 |
| Example 6 | method | | | | | | | |
| Example 7 | hydroxide | 800 | 300 | 2.6 | 4.35 | 225 | 0.03 | 86 |
| | method | | | | | | | |
| Example 8 | hydroxide | | | | 4.45 | 238 | 0.05 | 82 |
| | method | | | | | | | |
| Comparative | hydroxide | | | | 4.55 | 255 | 0.12 | 80 |
| Example 7 | method | | | | | | | |

In Table 2, the initial discharge capacity indicates discharge capacity at the 2^{nd} cycle.

In addition, the voltage drop was obtained by a difference between an arithmetic average of the discharge voltage at the 2^{nd} cycle and an arithmetic average of the discharge voltage at the 300th cycle.

Furthermore, the capacity retention was obtained by dividing the discharge capacity at the 300^{th} cycle by the discharge capacity at the 2^{nd} cycle.

On the other hand, as the voltage drop is smaller, a discharge curved line has a smaller shape change.

In addition, as the capacity retention is higher, cycle characteristics are better.

The results in Table 2 are shown in FIGS. 2 to 4.

FIG. 2 is a graph showing a correlation between the average primary particle diameter and the initial discharge capacity when indicates the average primary particle diameter (nm), and a vertical axis indicates the initial discharge capacity (mAh/g).

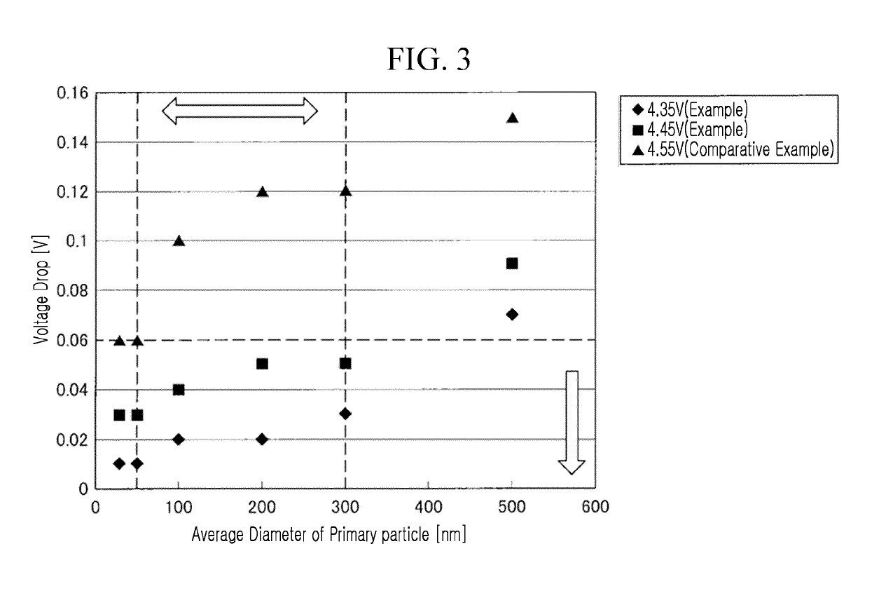

FIG. 3 is a graph showing a correlation between the average primary particle diameter and the voltage drop when a horizontal axis indicates the average primary particle diameter (nm), and a vertical axis indicates the voltage drop (V).

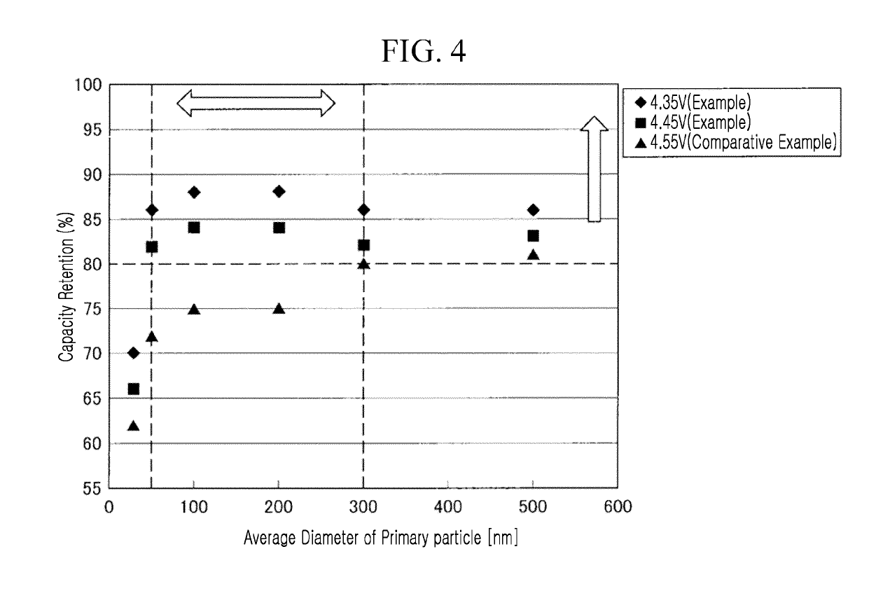

FIG. 4 is a graph showing a correlation between the average primary particle diameter and the cycle retention ratio when a horizontal axis indicates the average primary particle diameter (nm), and a vertical axis indicates the cycle retention ratio (%).

On the other hand, a triangular mark shown in FIGS. 2 to 4 indicates the measurement result of the rechargeable lithium ion battery cell at a charge voltage of 4.55 V during the cycles.

A quadrangular mark shown therein indicates the measurement result of the rechargeable lithium ion battery cell at a charge voltage of 4.45 V during the cycles.

A rhombus mark shown therein indicates the measurement result of the rechargeable lithium ion battery cell at a charge voltage of 4.35 V during the cycles.

Referring to Table 2 and FIGS. 2 to 4, the cells according to Examples 1 to 8 all showed high initial discharge capacity and simultaneously, a small voltage drop and a high cycle retention ratio.

On the other hand, Comparative Examples 1 to 3 having a smaller average primary particle diameter than that of the present invention showed high initial discharge capacity but a deteriorated cycle retention ratio.

In addition, Comparative Examples 3 to 7 having a charge voltage of 4.55 V during the cycles showed high initial discharge capacity but a large voltage drop.

Accordingly, Examples 1 to 8 having a charge voltage of less than 4.5 V during the cycles and simultaneously, an average primary particle diameter within the range of the present invention showed high initial discharge capacity and a high cycle retention ratio and simultaneously, a small voltage drop when charge and discharge were repeated.

In addition, Examples 1 to 8 showed a specific surface area satisfying the range of the present invention and respectively improved characteristics compared with Comparative Examples 1 to 7.

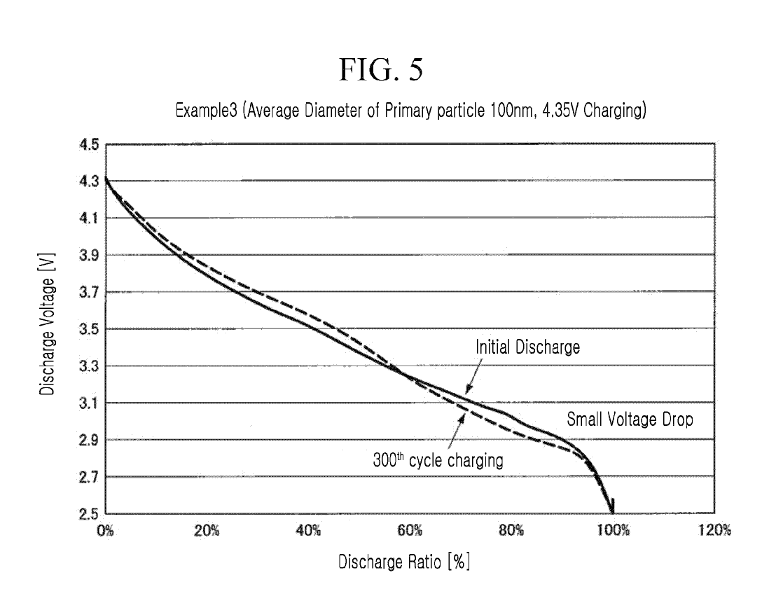

FIGS. 5 and 6 show the discharge curved lines of Examples 3 and 8 during the initial discharge (the 2^{nd} cycle) and during discharge (the 300^{th} cycle).

FIG. 5 is a graph showing the discharge curved lines of Example 3 during the initial discharge (the 2^{nd} cycle) and during discharge (the 300^{th} cycle).

As shown in FIG. 5, since the discharge curved line of Example 3 during the initial discharge is almost overlapped with the discharge curved line during the discharge at the 300^{th} cycle, a voltage drop by repetitive charge and discharge cycles is small.

As shown in the above results, according to one embodiment, cycle characteristics may be improved by using a Li₂MnO₃-based solid solution having an average primary particle diameter in a range of 50 nm to 300 nm, setting charge potential of a positive electrode at greater than or equal to 4.55 V vs. Li during the first charge and at less than 4.5 V from the 2^{nd} charge and thus, increasing discharge capacity and simultaneously, suppressing a voltage drop during charge and discharge.

In the present disclosure, the terms “Example” and “Comparative Example” are used arbitrarily to simply identify a particular example or experimentation and should not be interpreted as admission of prior art. While this disclosure has been described in connection with what is presently considered to be practical exemplary embodiments, it is to be understood that the invention is not limited to the disclosed embodiments and is intended to cover various modifications and equivalent arrangements included within the spirit and scope of the appended claims.

What is claimed is:

1. An rechargeable lithium ion battery, comprising
a positive electrode comprising a positive active material; a negative electrode; and an electrolyte,
wherein the rechargeable lithium ion battery is used at a voltage of less than about 4.5 V, and activated by performing a first cycle charging at a voltage of greater than or equal to about 4.55 V,
the positive active material is a ternary-component positive active material including a Li₂MnO₃-based solid solution, and
an average primary particle diameter of the Li₂MnO₃-based solid solution ranges from about 50 nm to about 300 nm.

2. The rechargeable lithium ion battery of claim 1, wherein the ternary-component positive active material including the Li₂MnO₃-based solid solution is represented by the following Chemical Formula 1:
xLi₂MnO₃-(1-x)LiMO₂ Chemical Formula 1
wherein, 0.3≦x≦0.5, and
M is represented by the following Chemical Formula 2,
MnₐCo_{b}Ni_{c} Chemical Formula 2
wherein, 0.2≦a≦0.5, 0.1≦b≦0.4, and 0.2≦c≦0.5.

3. The rechargeable lithium battery of claim 1, wherein the electrolyte solution concentration ranges from 0.5 mol/L to about 2.0 mol/L.

4. The rechargeable lithium ion battery of claim 1, wherein a specific surface area of the Li₂MnO₃-based solid solution ranges from about 2.5 m²/g to about 10 m²/g.

5. The rechargeable lithium ion battery of claim 1, wherein the ternary-component positive active material including the Li₂MnO₃-based solid solution additionally doped with a metal M′, and
is represented by the following Chemical Formula 1-1:
xLi₂MnO₃-(1-x)LiMM′O₂ Chemical Formula 1-1
wherein,
M′ is selected from Mg, Ti, V, Fe, Al, and a combination thereof,
0.3≦x≦0.5, and
M is represented by the following Chemical Formula 2,
MnₐCo_{b}Ni_{c} Chemical Formula 2
wherein, 0.2≦a≦0.5, 0.1≦b≦0.4, and 0.2≦c≦0.5.

6. The rechargeable lithium ion battery of claim 1:
wherein the rechargeable lithium ion battery is charged at a charge voltage of 4.35 V;
the specific surface area of the Li₂MnO₃-based solid solution is 8.3 m²/g;
the average primary particle diameter of the Li₂MnO₃-based solid solution ranges is 50 nm.

7. The rechargeable lithium ion battery of claim 1:
wherein the rechargeable lithium ion battery is charged at a charge voltage of 4.45 V;
the specific surface area of the Li₂MnO₃-based solid solution is 8.3 m²/g;
the average primary particle diameter of the Li₂MnO₃-based solid solution ranges is 50 nm.

8. The rechargeable lithium ion battery of claim 1:
wherein the rechargeable lithium ion battery is charged at a charge voltage of 4.35 V;
the specific surface area of the Li₂MnO₃-based solid solution is 6.2 m²/g;
the average primary particle diameter of the Li₂MnO₃-based solid solution ranges is 100 nm.

9. The rechargeable lithium ion battery of claim 1:
wherein the rechargeable lithium ion battery is charged at a charge voltage of 4.45 V;
the specific surface area of the Li₂MnO₃-based solid solution is 6.2 m²/g;
the average primary particle diameter of the Li₂MnO₃-based solid solution ranges is 100 nm.

10. The rechargeable lithium ion battery of claim 1:
wherein the rechargeable lithium ion battery is charged at a charge voltage of 4.35 V;
the specific surface area of the Li₂MnO₃-based solid solution is 4.5 m²/g;
the average primary particle diameter of the Li₂MnO₃-based solid solution ranges is 200 nm.

11. The rechargeable lithium ion battery of claim 1:
wherein the rechargeable lithium ion battery is charged at a charge voltage of 4.45 V;
the specific surface area of the Li₂MnO₃-based solid solution is 4.5 m²/g;
the average primary particle diameter of the Li₂MnO₃-based solid solution ranges is 200 nm.

12. The rechargeable lithium ion battery of claim 1:
wherein the rechargeable lithium ion battery is charged at a charge voltage of 4.35 V;
the specific surface area of the Li₂MnO₃-based solid solution is 2.6 m²/g;
the average primary particle diameter of the Li₂MnO₃-based solid solution ranges is 300 nm.

13. The rechargeable lithium ion battery of claim 1:
wherein the rechargeable lithium ion battery is charged at a charge voltage of 4.45 V;
the specific surface area of the Li₂MnO₃-based solid solution is 2.6 m²/g;
the average primary particle diameter of the Li₂MnO₃-based solid solution ranges is 300 nm.

14. A method of preparing a rechargeable lithium ion battery, comprising:
agitating co-precipitated dry powders of Mn, Co and Ni and lithium carbonate (Li₂CO₃) at 4 m/s to 5 m/s for about 8 hours to about 12 hours to prepare a mixed powder; and
firing the mixed powder at about 700° C. to about 850° C. for about 8 hours to about 12 hours to prepare a ternary-component positive active material including a Li₂MnO₃-based solid solution.

15. The method of claim 6, wherein the ternary-component positive active material including the Li₂MnO₃-based solid solution is represented by the following Chemical Formula 1:
xLi₂MnO₃-(1-x)LiMO₂ Chemical Formula 1
wherein, 0.3≦x≦0.5,
M is represented by the following Chemical Formula 2,
MnₐCo_{b}Ni_{c} Chemical Formula 2
wherein, in the above Chemical Formula 2, 0.2≦a≦0.5, 0.1≦b≦0.4, and 0.2≦c≦0.5.

16. The method of claim 6, wherein the firing is performed at about 700° C. to about 800° C.

17. The method of claim 14, wherein an average primary particle diameter of the Li₂MnO₃-based solid solution ranges from about 50 nm to about 300 nm.

18. The method of claim 6, wherein a specific surface area of the Li₂MnO₃-based solid solution ranges from about 2.5 m²/g to about 10 m²/g.

19. The method of claim 6, wherein the ternary-component positive active material including the Li₂MnO₃-based solid solution is additionally doped with a metal M′ and is represented by the following Chemical Formula 1-1:
xLi₂MnO₃-(1-x)LiMM′O₂ Chemical Formula 1-1
wherein,
M′ is selected from Mg, Ti, V, Fe, Al, and a combination thereof,
0.3≦x≦0.5, and
M is represented by the following Chemical Formula 2,
MnₐCo_{b}Ni_{c} Chemical Formula 2
wherein, 0.2≦a≦0.5, 0.1≦b≦0.4, and 0.2≦c≦0.5.

20. The method of claim 6, wherein the co-precipitated dry powder is a hydroxide of each metal element or a carbonate salt of each metal element.
